(19) United States
(12) Patent Application Publication
(10) Pub. No.: US 2013/0284737 A1
(43) Pub. Date: Oct. 31, 2013

(54) Graphite foil-bonded device and method for preparing same

(71) Applicant: NATIONAL CHENG KUNG UNIVERSITY, Tainan (TW)

(72) Inventors: Chien-Ping Ju, Kansas City, MO (US); Jiin-Huey Chern-Lin, Winnetka, IL (US); Kuo-Jung Lee, Tainan (TW); Hsun-Yu Lin, Kaohsiung (TW)

(73) Assignee: NATIONAL CHENG KUNG UNIVERSITY, Tainan (TW)

(21) Appl. No.: 13/872,295

(22) Filed: Apr. 29, 2013

Related U.S. Application Data
(60) Provisional application No. 61/640,109, filed on Apr. 30, 2012.

(51) Int. Cl. B32B 3/14; F16L 9/14; B32B 38/00; B65D 25/14; B32B 37/10; B29C 65/54

(52) U.S. Cl. CPC B32B 3/14; B32B 37/1018; B29C 65/54; B32B 38/0012; B65D 25/14; F16L 9/14
USPC 220/62.15; 428/98; 264/261; 264/29.1; 156/153; 264/162; 264/262; 138/141

(57) ABSTRACT

A device has a layered structure, and the layered structure has a graphite foil bonded to a surface of a substrate, wherein the graphite foil contains a laminate of a plurality of natural graphite flakes parallel to the surface of the substrate, wherein the graphite foil and the surface of the substrate are bonded through diffusion bonding directly, or bonded with a cured resin, a cured pitch, a carbonized resin, a carbonized pitch, a graphitized resin or a graphitized pitch in between, wherein the graphite foil contains not less than 95%, preferably 99%, of carbon.

### CROSS REFERENCE TO RELATED APPLICATIONS

This patent application claims the priority benefit of prior U.S. Provisional Patent Application Ser. No. 61/640,109, filed Apr. 30, 2012.

### FIELD OF THE INVENTION

The present invention is related to a device having a metallic, ceramic, carbonaceous or polymeric substrate and a graphite foil boned to a surface of the substrate, and related to a process for preparing the device comprising laying up a flexible graphite foil onto the surface of the substrate, wherein the flexible graphite foil comprise a plurality of natural graphite flakes parallel to the surface of the substrate.

### BACKGROUND OF THE INVENTION

Molten salt reactor (MSR) has been suggested as one promising Generation IV nuclear reactor which uses molten fluoride salt as fuel. Of the six nuclear reactor designs chosen for advanced research and development by the Generation IV International Forum, at least two will use molten fluoride salts as the primary coolant. Advantages of MSR includes superior safety (no “China Syndrome” with an always molten core), elimination of nuclear waste problem, breeding new nuclear fuel without the risk of nuclear proliferation, and ability to use plentiful, virtually renewable thorium far more efficiently than uranium as a nuclear fuel. Furthermore, MSR has potential of capable of operating at a temperature limit set by the boiling point of fluoride salts (about 1400° C.) with a very high thermal efficiency.

The use of carbonaceous materials in the nuclear power industry has a long history. Graphite and carbon-carbon (C/C) composites are used in a variety of high-temperature nuclear reactors. Due to their relatively high mechanical strengths, C/C composites have been developed for fusion and fission applications with short-term operating temperatures up to 1600° C.

C/C composites could be attractive for use with the molten salt-cooled Advanced High Temperature Reactor, molten salt reactors, and fusion power plants as construction material for high-temperature heat exchangers, piping, pumps, vessels, etc. for a variety of nuclear applications, due to their ability to maintain nearly full mechanical strength to high temperatures (up to 1400° C.).

Graphite is generally resistant to chemical attack by fluoride salts. Due to the relatively low mechanical strength of nuclear grade graphite, C/C composite has been highly recommended to be used for molten fluoride salt-cooled reactors and as structural containment for the highly corrosive molten fluoride salts in heat exchanger, piping, pump, and vessels for nuclear applications, due to their ability to maintain nearly full mechanical strength to high temperatures (up to 1400° C.),

Despite their excellent high temperature mechanical properties and chemical compatibility with molten fluoride salts, the inherently high porosity level (leading to a high permeability to the molten salts) of C/C composites is one major challenge to the material. Although chemical vapor deposition (CVD) or chemical vapor infiltration (CVI) technique is often used to densify the composite, the porosity problem of C/C composites cannot be completely solved. Furthermore, the numerous inherent and/or high temperature heat treatment-induced macrocracks and microcracks in C/C composites are extremely difficult to be sealed by conventional methods such as CVD or CVI.

WO 03/001133 A2 discloses a graphite-based anisotropic heat spreader or heat pipe prepared by a process comprising forming a laminate comprising a plurality of flexible graphite sheets which comprise graphene layers; and directionally aligning the graphene layers of the laminate by the application of pressure. Processes for preparing the flexible graphite sheet are also disclosed in WO 03/001133 A2.

### SUMMARY OF THE INVENTION

This invention discloses a device comprising at least one sheet of graphite foil wherein at least one portion of the sheet of graphite foil comprising natural graphite flakes. The device of the present invention is highly resistant to chemical reaction and/or permeation/penetration of a highly corrosive environment, for example, an environment comprising high-temperature molten fluoride salts comprising LiF, NaF, and/or KF. This invention also discloses a method for preparing the device. The applications of the inventive device are not limited to the use for heat exchangers. Any other applications requiring properties, such as high thermal conductivity, high temperature and/or high corrosion resistance, high temperature strength and/or modulus, surface/subsurface pore sealing, etc. can also take advantages of the present inventive device. The inventive device is also a potential candidate for use as the first-wall material in fusion reactors. The flexibility/softness and tightly packed/compressed graphite flakes of the graphite foil also makes the inventive device an ideal candidate for use as a sealing material/device such as nuts, bolts, screws, valves, joints, connectors, gaskets, etc. in a hostile environment.

A composite constructed according to the present invention comprises a layered structure comprising a graphite foil bonded to a surface of a substrate, wherein the graphite foil comprises a laminate of a plurality of natural graphite flakes parallel to the surface of the substrate, wherein the graphite foil and the surface of the substrate are bonded through diffusion bonding directly, or bonded with a cured resin, a cured pitch, a carbonized resin, a carbonized pitch, a graphitized resin or a graphitized pitch in between, wherein the graphite foil contains not less than 95%, preferably 99%, of carbon.

Preferably, the substrate is a metallic or ceramic substrate, and more preferably a metallic substrate, and the graphite foil and the surface of the substrate are bonded through diffusion bonding directly.

Preferably, the metallic substrate is stainless steel, titanium, a titanium alloy, a superalloy, copper, a copper alloy or an aluminum alloy.

Preferably, the substrate is a metallic, ceramic, carbonaceous or polymeric substrate, and the graphite foil and the surface of the substrate are bonded with a cured resin, a cured pitch, a carbonized resin, a carbonized pitch, a graphitized resin or a graphitized pitch, in between.

Preferably, the resin is a thermosetting resin.

Preferably, the substrate is a carbonaceous substrate, and more preferably, the carbonaceous substrate is a carbon fiber-reinforced carbon matrix composite substrate or a graphite block substrate, and most preferably a carbon fiber-reinforced carbon matrix composite substrate.

Preferably, the substrate is in the form of a pipe or tank and the surface is an inner wall of the pipe or tank.

A process of making a composite disclosed in accordance with the present invention comprises placing a flexible graphite foil onto a surface of a metallic or ceramic substrate, preferably a metallic substrate, to form a layered structure; and diffusion bonding the flexible graphite foil and the surface of the substrate by compressing the layered structure in an inert atmosphere or under vacuum at a temperature of 200-1200° C., preferably 300-1100° C., wherein the flexible graphite foil comprises a laminate of a plurality of natural graphite flakes parallel to the surface of the substrate, wherein the flexible graphite foil contains not less than 90%, preferably 95%, of carbon.

Another process of making a composite disclosed in accordance with the present invention comprises providing a substrate and a flexible graphite foil, wherein the substrate, the flexible graphite or both comprise resin or pitch deposited on a surface thereof; placing a flexible graphite foil onto the surface of the substrate to form a layered structure, wherein the flexible graphite foil comprises a laminate of a plurality of natural graphite flakes parallel to the surface of the substrate, and the flexible graphite foil contains not less than 90%, preferably 95%, of carbon; and compressing the layered structure at an elevated temperature, so that at least a portion of resin or pitch is softened and flows between the graphite foil and the substrate.

Preferably, the substrate is provided with resin or pitch deposited on a surface thereof, and the flexible graphite foil does not comprise resin or pitch.

Preferably, the compressing is carried out at a temperature of 50-300° C., preferably 100-200° C., and a pressure of 1-100 MPa, preferably 1-50 MPa, for a period of 1-1000 minutes, preferably 1-100 minutes.

Preferably, the substrate is a carbonaceous substrate, and more preferably, the carbonaceous substrate is a carbon fiber-reinforced resin matrix composite substrate, a carbon fiber-reinforced pitch matrix composite substrate, a resin or pitch impregnated carbon fiber-reinforced carbon matrix composite substrate or a resin or pitch impregnated graphite block substrate.

Preferably, the substrate is a resin-coated metallic substrate.

Preferably, said another process of the present invention further comprises post-curing at least partially cured resin or pitch in the compressed layer structure. More preferably, said another process of the present invention further comprises carbonizing, and optionally graphitizing the post-cured resin or post-cured pitch.

Preferably, wherein the surface of the flexible graphite foil or the substrate is roughened prior to the flexible graphite foil being placed onto the surface of the substrate.

### BRIEF DESCRIPTION OF THE DRAWINGS

FIG. 1 is a cross-sectional SEM micrograph of a graphite foil-C/C composite prepared in Example 1 of the present invention.

FIG. 2 are cross-sectional SEM micrographs of graphite foil-C/C composites prepared in Example 2 of the present invention: (a) R/R; (b) R/P; (c) P/R; (d) P/P.

FIG. 3 are cross-sectional SEM micrographs of graphite foil-C/C composites prepared in Example 3 of the present invention.

FIG. 4 are photographs showing water contact angles of (a) C/C composite without graphite foil; (b) commercial high density graphite; and (c) a graphite foil-C/C composite of the present invention.

FIG. 5 are cross-sectional SEM morphology of (a) a Flinak-immersed graphite foil-C/C (R/R) composite of the present invention, (b) C map, and (c) F map thereof.

FIG. 6 are cross-sectional SEM micrographs of (a) of a Flinak-immersed graphite foil-C/C (R/R) composite of the present invention with a 0.5 mm dia. hole drilled through the graphite foil, as highlighted by the arrow, (b) C map, and (c) F map thereof.

FIG. 7 are SEM micrographs of a graphite foil-C/C composite of the present invention (a) before, and (b) after immersion test in Flinak.

FIG. 8 are SEM micrographs of a commercial NBG-18 graphite (a) before, and (b) after immersion test in Flinak.

FIG. 9 are SEM micrographs of a graphite foil-C/C composite of the present invention (a) before, and (b) after erosion test in Flinak.

FIG. 10 are SEM micrographs of a commercial NBG-18 graphite (a) before, and (b) after erosion test in Flinak.

FIG. 11 are broad face ((a), (c), (e)), and cross-sectional ((b), (d), (f)) morphologies of a graphite foil-graphite composite prepared in Example 9 of the present invention under different process stages.

FIG. 12a is a plot showing diffusion bonding behavior of inventive graphite foil-SS 304 composite.

FIG. 12b shows a cross-sectional SEM micrograph of a graphite foil-SS 304 composite diffusion-bonded at 800° C. for 1 h according to the present invention.

FIG. 13a is a plot showing diffusion bonding behavior of inventive graphite foil-SS 316 composite.

FIG. 13b shows a cross-sectional SEM micrograph of a graphite foil-SS 316 composite diffusion-bonded at 800° C. for 1 h according to the present invention.

FIG. 14a is a plot showing diffusion bonding behavior of inventive graphite foil-c.p. Ti composite.

FIG. 14b shows a cross-sectional SEM micrograph of a graphite foil-c.p. Ti composite diffusion-bonded at 800° C. for 5 h according to the present invention.

FIG. 15a is a plot showing diffusion bonding behavior of inventive graphite foil-Ti6-Al4-V composite.

FIG. 15b shows a cross-sectional SEM micrograph of a graphite foil-Ti6-Al4-V composite diffusion-bonded at 800° C. for 5 h according to the present invention.

FIG. 16a is a plot showing diffusion bonding behavior of inventive graphite foil-800H superalloy composite.

FIG. 16b shows a cross-sectional SEM micrograph of a graphite foil-800H superalloy composite diffusion-bonded at 800° C. for 1 h according to the present invention.

FIG. 17a is a plot showing diffusion bonding behavior of inventive graphite foil-Hastelloy superalloy composite.

FIG. 17b shows a cross-sectional SEM micrograph of a graphite foil-Hastelloy superalloy composite diffusion-bonded at 800° C. for 1 h according to the present invention.

FIG. 18a is a plot showing diffusion bonding behavior of inventive graphite foil-copper composite.

FIG. 18b shows a cross-sectional SEM micrograph of a graphite foil-copper composite diffusion-bonded at 800° C. for 1 h according to the present invention.

FIG. 19 is a plot showing diffusion bonding behavior of inventive graphite foil-brass composite.

FIG. 20a is a plot showing diffusion bonding behavior of inventive graphite foil-phosphor bronze composite.

FIG. 20b shows a cross-sectional SEM micrograph of a graphite foil-phosphor bronze composite diffusion-bonded at 800° C. for 1 h according to the present invention.

### DETAILED DESCRIPTION OF THE INVENTION

The term “graphite foil” used in the present invention is a general term representing any graphite layer comprising natural graphite (preferably natural graphite flakes) or any processed graphite sheet from natural graphite, wherein the graphite flakes or graphite sheets as well as the basal planes therein are highly aligned to be parallel to the surface of the graphite foil. It may also be termed as “graphite sheet”, “flexible graphite sheets”, “graphite paper”, “Grafoil®” (a commercial product), etc., and may be prepared from different processes and methods commonly known in this field, for example a suitable method for preparing the “graphite foil” comprises compressing or calendering certain amount of intercalated and exfoliated natural graphite into a sheet of graphite foil with a desirable thickness and density.]

The invention of the present invention includes but not limited to the following aspects:

(1) A composite device comprising at least one sheet of graphite foil wherein at least a portion of the sheet of graphite foil comprising natural graphite; and said graphite foil is bonded onto a substrate.
(2) The device of aspect (1), wherein said natural graphite is in the form of natural graphite flakes.
(3) The device of aspect (1), wherein said sheet of graphite foil is a graphite sheet processed from natural graphite flakes.
(4) The device of aspect (1), wherein the substrate is made from a metallic material, a ceramic material, a carbonaceous material, or a polymeric material.
(5) The device of aspect (1), wherein said graphite foil is bonded onto a substrate is conducted by diffusion bonding, chemical vapor infiltration, or a polymeric glue.
(6) The device of aspect (4), wherein the metallic material is a stainless steel, a titanium or titanium alloy, a copper or copper alloy, a superalloy, or an aluminum alloy.
(7) The device of aspect (4), wherein the ceramic material is a SiC, Si₃N₄, ZrO₂, or Al₂O₃.
(8) The device of aspect (4), wherein the carbonaceous material is a graphite.
(9) The device of aspect (4), wherein the carbonaceous material is a carbon fiber-reinforced carbon matrix composite (C/C composite).
(10) The device of aspect (4), wherein the polymeric material is a thermosetting polymer.
(11) The device of any one of aspect (6) to (10) is in a form of a pipe or tank, wherein said graphite foil is bonded onto the inner wall of said pipe or tank.
(12) The device of aspect (9), which is prepared by a method comprising following steps:
(i) preparing a carbon fiber or carbon fiber preform, carbon matrix (binder) precursor, and optionally certain desirable matrix additives; wherein the carbon fiber or carbon fiber preform may be pre-combined with the carbon matrix precursor to form a prepreg, if so desired;
(ii) preparing a graphite foil comprising natural graphite (preferably natural graphite flakes) or any processed graphite sheet from natural graphite.
(iii) stacking the fiber or fiber preform, matrix precursor (or their pre-combined prepreg) and the graphite foil together in a mold, forming a stacked composite with a desirable shape and lay-up pattern;
(iv) hot-pressing the stacked composite in the mold, preferably under a pressure about 1-100 MPa and preferably at a temperature about 50-300° C., to form a graphite foil-C/C composite green body;
(v) optionally post-curing the hot-pressed graphite foil-C/C composite green body preferably at a temperature about 70-400° C.;
(vi) carbonizing the hot-pressed or post-cured graphite foil-C/C composite article preferably to a temperature about 500-1500° C. in a non-oxidative atmosphere;
(vii) optionally graphitizing the carbonized graphite foil-C/C composite article preferably to a temperature about 1500-3000° C. in a non-oxidative environment;
(viii) optionally further densifying the carbonized or graphitized C/C/graphite foil composite article by at least one further matrix infiltration/carbonization densification cycle;
(ix) optionally the surface without graphite foil is protected by a ceramic, preferably SiC, layer.
(x) optionally the incorporation of said graphite foil in step (iii) is conducted in the middle of multiple densification cycles.
(xi) optionally the incorporation of said graphite foil in step (iii) is conducted after the final densification cycle.
   (12a) The device of aspect (9) (for commercially available C/C substrate) which is prepared by a method comprising following steps:
(i) preparing a C/C composite article; optionally said article surface is roughened and/or coated with a curable resin;
(ii) preparing a graphite foil comprising natural graphite (preferably natural graphite flakes) or any processed graphite sheet from natural graphite; optionally said C/C composite article surface is roughened and/or coated with a curable resin;
(iii) stacking the graphite foil onto at least one surface of said C/C composite article, preferably in a mold, forming a stacked composite;
(iv) hot-pressing the stacked composite, preferably, in the mold, preferably under a pressure about 1-100 MPa and preferably at a temperature about 50-300° C., to form a composite green body;
(v) optionally post-curing the hot-pressed composite green body preferably at a temperature about 70-400° C.;
(vi) carbonizing the hot-pressed or post-cured composite article preferably to a temperature about 500-1500° C. in a non-oxidative atmosphere;
(vii) optionally graphitizing the carbonized composite article preferably to a temperature about 1500-3000° C. in a non-oxidative environment;
(xii) optionally the surface without graphite foil is protected by a ceramic, preferably SiC, layer.
   (13) The device of aspect (8), which is prepared by a method comprising following steps:
(i) preparing a graphite substrate; optionally said graphite substrate surface is roughened and/or coated with a curable resin;
(ii) preparing a graphite foil comprising natural graphite (preferably natural graphite flakes) or any processed graphite sheet from natural graphite; optionally said graphite foil surface is roughened and/or coated with a curable resin;
(iii) stacking said graphite substrate and the graphite foil together in a mold, forming a stacked composite;
(iv) hot-pressing the stacked composite in the mold, preferably under a pressure about 1-100 MPa and preferably at a temperature about 50-300° C., to form a graphite foil-graphite substrate composite green body;
(v) optionally post-curing the hot-pressed composite green body preferably at a temperature about 70-400° C.;
(vi) carbonizing the hot-pressed or post-cured composite article preferably to a temperature about 500-1500° C. in a non-oxidative atmosphere;
(vii) optionally graphitizing the carbonized composite article preferably to a temperature about 1500-3000° C. in a non-oxidative environment;
(viii) optionally the surface without graphite foil is protected by a ceramic, preferably SiC, layer.
   (14) The device of aspect (6) or (7), which is prepared by a method comprising following steps:
(i) preparing a metallic or ceramic substrate; optionally said substrate surface is roughened and/or coated with a curable resin;
(ii) preparing a graphite foil comprising natural graphite (preferably natural graphite flakes) or any processed graphite sheet from natural graphite; optionally said graphite foil surface is roughened and/or coated with a curable resin;
(iii) allowing said substrate and said graphite foil to be in intimate contact to form a graphite foil/substrate laminate;
(iv) heating said laminate (preferably in vacuum or an inert atmosphere; preferably at a temperature above 200° C.; more preferably about 300-1200° C.) to allow said substrate and said graphite foil to be diffusion-bonded.
   (15) The device of aspect (11), wherein the device is the form of a pipe, and the device is prepared by a method comprising following steps:
(i) preparing a pipe; optionally the inner surface of said pipe is roughened and/or coated with a curable resin;
(ii) preparing a graphite foil comprising natural graphite (preferably natural graphite flakes) or any processed graphite sheet from natural graphite; optionally said graphite foil surface is roughened and/or coated with a curable resin;
(iii) preparing an insert (preferably made from copper or a copper alloy) with a diameter slightly less than the inner diameter of the pipe and with a CTE (coefficient of thermal expansion) no less than the CTE of the pipe in radial direction;
(iv) inserting said graphite foil and said insert into the interior of the pipe so that the graphite foil is sandwiched between pipe and insert; and allowing the graphite foil, the insert and the inner wall of the pipe in intimate contact;
(v) heating the insert/graphite foil-filled pipe (preferably in vacuum or an inert atmosphere) to allow pipe inner wall and graphite foil to be diffusion-bonded.
(vi) removing insert from pipe.

The device of the present invention is highly resistant to chemical reaction and/or permeation/penetration of a highly corrosive environment, for example, an environment comprising high-temperature molten fluoride salts comprising LiF, NaF, and KF. The device of the present invention can be in any form.

Preferably the substrate is in a form of a pipe or tube, if used as a heat exchanger, wherein said graphite foil is bonded onto the inner wall of said pipe or tube.

Further features of the method disclosed in the aspect (12) of the present invention includes:

In step (i), the carbon fiber, either a long/continuous fiber or a short/chopped fiber, is preferably a PAN (polyacrylonitrile)-based fiber or a pitch-based fiber. The short carbon fiber in the preform or prepreg may be individually distributed (randomly or with a designed pattern) or in a chopped bundle form. The long carbon fiber in the preform or prepreg may be unidirectional, multi-directionally woven, or needled. The matrix precursor is preferably a resin or pitch. The matrix additive may be graphite powder, mesophase pitch powder, carbon black, Si, or ceramic powder such as SiC, carbon nanotube (CNT), graphene, etc.

In step (ii), the graphite foil comprising natural graphite (preferably natural graphite flakes) or any processed graphite sheet from natural graphite may be fabricated by any technique commonly known in this field, for example, by compressing or rolling anisotropic layers of exfoliated natural graphite with or without a binder. To increase the “z axis” (perpendicular to the foil broad face) thermal conductivity, the graphite foil may comprise additives such as graphite powder, mesophase pitch powder, carbon black, carbon nanotube (CNT), graphene, etc. These additives may be mixed with natural graphite flakes, followed by compressing or rolling the mixture into thin flexible graphite sheets with or without a binder. Another way to increase the “z axis” thermal conductivity is to allow at least a portion of the graphite flakes (and thus the basal planes therein) aligning with an angle with the graphite foil surface. This may be achieved by cutting/grinding a normal graphite sheet at an angle with the graphite flakes, so that the graphite flakes will not be totally parallel to the graphite foil surface. Another way to increase the “z axis” thermal conductivity is to prepare a non-flat graphite foil surface. This non-flat graphite foil surface may be prepared by hot-pressing the graphite foil/C/C composite into a mold wherein the top and/or bottom inner surface(s) is/are non-flat.

In step (iii), the graphite foil (either single-layered or multi-layered) may be incorporated anywhere in the stacked composite, but preferably incorporated at the outer surface (bonded to the surface of the C/C composite), so that the graphite foil will directly contact the highly corrosive molten salts (serving as a “first wall” material), thus sealing/protecting the underneath C/C structure.

Although a number of different techniques, for example, needling or chemical vapor infiltration (CVI)/chemical vapor deposition (CVD), may be used to bond the graphite foil to the C/C structure, all these techniques have high risks for leaking and/or microcracking, especially during heating and/or cooling of high temperature processing (for example, carbonization or graphitization).

Surprisingly it is discovered that, during hot pressing, the matrix material (for example, a phenolic resin or a pitch) becomes softened and can flow into the thin space between the graphite foil and the C/C laminates. Acting like glue, the matrix material filling the interfacial space adherently bonds the two parts together. Even more surprisingly it is discovered that, after the high-temperature graphitization treatment, the interfacial layer remains very dense and the bonding remains very tight without any delamination or microcracking being noticed in the interfacial area. Due to its lack of liquid-flowing stage, CVI carbon cannot be used as primary/initial matrix (filling/densifying a dry fiber preform). CVI, however, may be used for further densification of a carbonized, porous matrix after a tight bond has already been formed.

The graphite foil may be installed at the early process stage, for example, prior to hot pressing, as mentioned above. The graphite foil may also be installed at the final stage, for example, after the final densification cycle. One advantage for the graphite foil being installed at the final stage is that, in so doing, the densification cycles can be more efficient due to more free surfaces (open channels) being available. When the graphite foil is installed at the early stage, although the bonding between the graphite foil and C/C substrate may be stronger, the presence of the graphite foil can always somewhat hinder the release of carbonization-induced gases. Alternatively, the graphite foil may be installed in the middle of the assigned several densification cycles.

The graphite foil may be installed onto essentially any type of C/C composite, commercially available or not.

To increase thermal conductivity of the composite, high conductivity materials, such as carbon nanotube (CNT), graphene, etc., may be optionally added into the matrix.

In step (iv), the mold for hot pressing (also for stacking in step (iii)) may be of any shape and geometry, depending on the application. For use as heat exchangers, a tubular shape is preferred. The hot pressing may be conducted in air, inert atmosphere, or under vacuum, for example, using an autoclave.

In step (v), the post-curing may be conducted in a furnace without pressure, or under pressure to reduce bloating of the sample (especially made from a two-dimensionally woven preform).

In step (vi), the non-oxidative environment may be any environment wherein oxidation reaction of carbon is negligible. Two common sources for carbon oxidation are oxygen and water vapor. Nitrogen, inert gas, or vacuum may be used as the carbonization environment.

The heating rate of carbonization may be in a wide range, for example, from about 1° C./min to about 1000° C./min.

Alternatively, for reducing porosity level, a low speed (e.g., from about 1° C./min to about 10° C./min) carbonization treatment may be applied during the final stage, while high speed carbonization treatment being applied during earlier cycles.

Alternatively, a pre-carbonization treatment at a lower heating rate may be applied prior to the carbonization treatment.

In step (vii), the graphitization may be conducted in vacuum or an inert gas atmosphere, for example, argon or helium. Due to its high temperature reactivity with carbonaceous material, nitrogen gas, though being commonly used as a carbonization atmosphere, may be inappropriate for graphitization of carbons, especially for the graphitization conducted at high temperatures (for example, >2000° C.). Optionally a pre-graphitization treatment at a lower heating temperature may be applied prior to the graphitization treatment.

In step (viii), additional cycles of matrix infiltration, carbonization and optionally graphitization may be conducted, depending on the density and properties desired. Optionally CVI may be used for these additional densification cycles, as long as a successful bonding has been established between the graphite foil and the C/C structure using the inventive method.

In step (ix), for oxidation protection purpose, the surface (preferably, but not limited to, the non-molten salting-contacting surface-the opposite side to that directly contacting molten salt) is further protected by a SiC layer. The SiC layer may be prepared by chemical vapor deposition (CVD) or surface reaction with liquid or solid Si-containing material.

Further features of the method disclosed in the aspect (13) of the present invention includes:

In step (i), the graphite can be any conventional graphite. For use as a heat exchanger in a nuclear reactor, nuclear grade graphite is preferred.

The features in step (ii) are the same of those recited in step (ii) of the method disclosed in the aspect (12).

In steps (iv)-(vii), the graphite foil (either single-layered or multi-layered) is bonded onto the surface of the graphite substrate, so that the graphite foil will directly contact the highly corrosive molten salts (serving as a “first wall” material), thus sealing/protecting the underneath graphite structure.

Although a number of different techniques, for example, CVI/CVD, may be used to bond the graphite foil to the graphite substrate, the aforementioned method for bonding graphite foil to C/C substrate (hot pressing, post-curing, carbonization, etc.) is recommended.

In step (viii), for oxidation protection purpose, the surface (preferably, but not limited to, the non-molten salting-contacting surface-the opposite side to that directly contacting molten salt) is further protected by a SiC layer. The SiC layer may be prepared by chemical vapor deposition (CVD) or surface reaction with liquid or solid Si-containing material.

Further features of the method disclosed in the aspect (14) of the present invention includes:

In step (i), the metallic material can be any metallic engineering material. Preferably the metallic material is a titanium alloy, a superalloy, or an aluminum alloy. The ceramic material can be any ceramic engineering material. Preferably the ceramic material is a SiC, Si₃N₄, ZrO₂, or Al₂O₃.

The features in step (ii) are same as those in step (ii) above.

In step (iii), said in intimate contact can be achieved by any conventional methods, e.g., clapping, fastening, nailing, gluing, etc.

In step (iv), said heating can be conducted by any conventional methods, e.g., resistance heating, conduction heating, etc., and in any conventional environment, preferably in vacuum or inert atmosphere.

Further features of the method disclosed in the aspect (15) of the present invention includes:

In step (i), said pipe can be made from a metallic material, a ceramic material, a carbonaceous material, or a polymeric material. The cross-section of the pipe can be in any shape, preferably circular or rectangular.

The features in step (ii) are same as those in step (ii) above.

In step (iii), said insert can be made from any conventional material, preferably made from materials that do not chemically react with graphite seriously at high temperatures, for example, copper or copper alloys. The inserts can be solid or hollow. Preferably the insert has a coefficient of thermal expansion (CTE) greater than that of the pipe in radial direction, so that, when heated, the insert can push the graphite foil against the inner wall of the pipe, helping the diffusion-bonding process, as described in step (v).

In step (iv), in order to allow the graphite foil, the insert and the inner wall of the pipe to be in intimate contact, the diameter of the insert should be slightly less than the inner diameter of the pipe. The graphite foil may be first wrapped onto the insert surface, then the graphite foil-wrapped insert is slid into the pipe, or the graphite foil may be first applied onto the inner surface of the pipe, then the insert is slid into the “graphite foil pipe.”

In step (v), said heating can be conducted by any conventional methods, e.g., resistance heating, conduction heating, etc., and in any conventional environment, preferably in vacuum or inert atmosphere.

In step (vi), in order to easily remove the insert from the pipe, the insert should not seriously chemically react with graphite at high temperatures.

### Example 1

### Manufacturing of an Inventive Graphite Foil-C/C Composite

Carbon fiber preform: PAN-based 2D woven cloths (Torayca T300—2×2 Twill, Toray Co., Japan)
Matrix precursor: Resole-type phenolic resin (PF-650, Chang Chun Plastics Co. Ltd., Taiwan)

Five pieces of PAN-based 2D woven cloths (Torayca T300—2×2 Twill, Toray Co., Japan) were laid-up and punch-needled. During the punch-needled, 291 needles punched on the woven cloths for 1500 times. The area of punch-needled was a circle of 11 cm in diameter. The needled felt was impregnated by the vacuum impregnation process with a resole-type phenolic resin (PF-650, Chang Chun Plastics Co. Ltd., Taiwan) at the temperature of 25-30° C., followed by heating in an oven at 70° C. for 6 hours to remove solvent from the resin and form a PAN/phenolic-based prepreg. The prepreg was cut to a square of 11 cm in length. A piece of graphite foil (GRAFOIL® GTA, Graftech International Ltd., USA) was shaped to a square of 11 cm in length, roughened by sand blast with the pressure of 20 psi for 1 sec, and laid-up (stacked) on top of the prepreg, followed by hot-pressing in a stainless steel mold at 160° C. for 30 min under a pressure of 5 MPa to form a graphite foil-C/C composite green body.

The hot-pressed composite green body was post-cured in an air-circulated oven at 230° C. for 8 hours. The post-cured graphite foil-C/C composite was carbonized (first carbonization) in a furnace in nitrogen atmosphere at 1100° C. for 1 hour at a heating rate of 10° C./min. The carbonized composite was graphitized at 1900° C. for 1 hour in a furnace with argon atmosphere. After the graphitization treatment, the composite was densified by vacuum impregnation of a resole-type phenolic resin (PF-650, Chang Chun Plastics Co. Ltd., Taiwan) at the temperature of 25-30° C., followed by curing at 180° C. for 2 hours and carbonization at 1100° C. for 3 min with a heating rate of 1000° C./min in a furnace with nitrogen atmosphere. Such impregnation/curing/carbonization cycle was repeated four times to obtain a desired density. After the densification procedure, pre-graphitization treatment at 1100° C. for 60 min with a heating rate of 10° C./min in a furnace with nitrogen atmosphere and final graphitization treatment at 1900° C. for 60 min in a furnace with argon atmosphere was applied to specimen. (Note: For many cases this final graphitization treatment is not required for the fabrication of C/C composites).

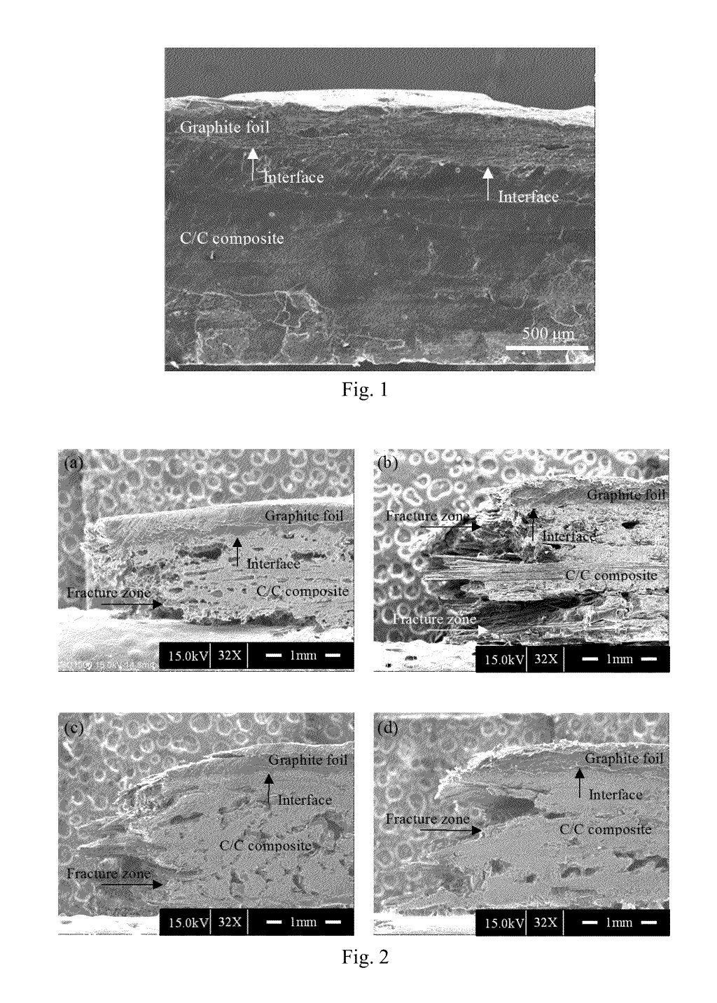

FIG. 1 is a typical scanning electron micrograph (SEM) showing a cross-section of thus-prepared graphite foil-C/C composite. It is worth noting that the graphite foil-C/C interface is very tight and the graphite foil itself is very dense in structure.

### Example 2

### Density, Porosity and Three-Point Bending Properties of Inventive Graphite Foil-C/C Composites

Carbon fiber preform: Punch-needled felt (Torayca T300—2×2 Twill, Toray Co., Japan)
Matrix precursor in pregreg: Resole-type phenolic resin (PF-650, Chang Chun Plastics Co. Ltd., Taiwan) or petroleum pitch (A240, Ashland Oil Company, USA)
Matrix precursor in densification/impregnation: Resole-type phenolic resin (PF-650, Chang Chun Plastics Co. Ltd., Taiwan) or petroleum pitch (A240, Ashland Oil Company, USA)

A series of graphite foil-C/C composites were manufactured following the general sequence given in Example 1 with different material and process details, as listed in Table 1. Different sample designations are listed in Table 2.

Density, porosity and three-point bending properties of thus-prepared composites are listed in Table 3.

Density and porosity values were determined using water saturation method according to ASTM C830 standard.

Three-point bending strength and toughness values were determined using SHIMADZU AGS-500D universal tester according to ASTM D790. Bending is conducted at a crosshead speed of 0.5 mm/min. Support span-thickness ratio of the samples is 16. Cross-sectional scanning electron micrographs of the various bending-fractured graphite foil-C/C composite samples are shown in FIG. 2. It is amazing to note that, no matter which type of matrix (resin or pitch) used, the graphite foil-C/C interface in all four different samples remains very tight and the graphite foil itself is very dense in structure (even adjacent to the highly-stressed fracture zone), even though all the composites have experienced two times of high temperature treatment at 1900° C., four times of fast cooling, and final bending to fracture.

TABLE 1
Materials and process parameters for preparing inventive
graphite foil-C/C composite samples for the study

| | | | Dura- | |
|---|---|---|---|---|
| | Matrix | Temperature | tion | Heating |
| Treatment | precursor | (° C.) | (min) | environment |
| Hot-pressing | Resin (prepreg) | 160 | 30 | Vacuum |
| Hot-pressing | Pitch (prepreg) | 120 | 30 | Vacuum |
| Post-curing | Resin (prepreg) | 230 | 480 | Air |
| Post-curing | Pitch (prepreg) | 120 | 480 | Air |
| Post-curing | Resin | 180 | 120 | Air |
| | (densification) | | | |
| Post-curing | Pitch | 70 | 120 | Air |
| | (densification) | | | |
| First | Resin, pitch | 1100 | 60 | N₂ |
| carbonization* | | | | |
| Graphitization | Resin, pitch | 1900 | 60 | Ar |
| Carbonization*** | Resin, pitch | 1100 | 3 | N₂ |
| | (densification) | | | |
| **Pre- | Resin and pitch | 1100 | 60 | N₂ |
| graphitization | | | | |
| **Final | Resin and pitch | 1900 | 60 | Ar |
| graphitization | | | | |

*Heating rate for first carbonization: 10° C./min
**Heating rate for the pre-graphitization treatment: 10° C./min
***Heating rate: 1000° C./min

TABLE 2
Sample codes for the study

| | | Matrix | Matrix precursor |
|---|---|---|---|
| | | precursor | (densification/ |
| Sample code | Graphite foil | (prepreg) | impregnation) |
| R/R | Yes | Resin | Resin |
| R/P | Yes | Resin | Pitch |
| P/R | Yes | Pitch | Resin |
| P/P | Yes | Pitch | Pitch |

TABLE 3
Density, porosity and three-point bending
properties of inventive composites

| Sample | Density | | Flexural | Flexural |
|---|---|---|---|---|
| code | (g/cm³) | Porosity (%) | strength (MPa) | toughness (MPa) |
| R/R | 1.28 ± 0.02 | 14.87 ± 0.47 | 71.0 ± 7.9 | 0.58 ± 0.01 |
| R/P | 1.28 ± 0.02 | 15.21 ± 1.12 | 65.9 ± 7.1 | 0.56 ± 0.01 |
| P/R | 1.29 ± 0.03 | 17.44 ± 0.80 | 50.3 ± 6.3 | 0.97 ± 0.07 |
| P/P | 1.28 ± 0.05 | 22.96 ± 2.55 | 41.0 ± 1.7 | 0.73 ± 0.00 |

### Example 3

### Density, Porosity and Three-Point Bending Properties of Inventive Graphite Foil-C/C Composites with Low Heating Rate Carbonization

Carbon fiber preform: PAN-based 2D woven cloths (Torayca T300—2×2 Twill, Toray Co., Japan)
Matrix precursor: Resole-type phenolic resin (PF-650, Chang Chun Plastics Co. Ltd., Taiwan) and petroleum pitch (A240, Ashland Oil Company, USA)

Five pieces of PAN-based 2D woven cloths (Torayca T300—2×2 Twill, Toray Co., Japan) were laid-up and punch-needled. During the punch-needled, 171 needles punched on the woven cloths for 500 times. The area of punch-needled was a square of 5 cm in length. The needled felt was impregnated by the vacuum impregnation process with a resole-type phenolic resin (PF-650, Chang Chun Plastics Co. Ltd., Taiwan) at the temperature of 25-30° C. or petroleum pitch (A240, Ashland Oil Company, USA) at the temperature of 250-300° C.

The resin-impregnated woven was baked in an oven at 70° C. for 6 hours to remove solvent from the resin and form a PAN/resin-based prepreg. The PAN/resin-based prepreg was cut to a square of 5 cm in length. A piece of graphite foil (GRAFOIL® GTA, Graftech International Ltd., USA) was shaped to a square of 5 cm in length, roughened by sand blast with the pressure of 20 psi for 1 sec, and laid-up (stacked) on top of the prepreg, followed by hot-pressing in a stainless steel mold at 160° C. for 30 min under a pressure of 5 MPa to form a graphite foil-C/C composite green body. The hot-pressed composite green body was post-cured in an air-circulated oven at 230° C. for 8 hours. The post-cured graphite foil-C/C composite was carbonized (first carbonization) in a furnace in nitrogen atmosphere at 1100° C. for 1 hour at a heating rate of 1° C./min. The carbonized composite was graphitized at 1900° C. for 1 hour in a furnace with argon atmosphere.

The pitch-impregnated woven was baked in an oven at 50° C. for 6 hours to remove solvent from the pitch and form a PAN/pitch-based prepreg. The PAN/pitch-based prepreg was cut to a square of 5 cm in length. A piece of graphite foil (GRAFOIL® GTA, Graftech International Ltd., USA) was shaped to a square of 5 cm in length, roughened by sand blast with the pressure of 20 psi for 1 sec, and laid-up (stacked) on top of the prepreg, followed by hot-pressing in a stainless steel mold at 120° C. for 30 min under a pressure of 5 MPa to form a graphite foil-C/C composite green body. The hot-pressed composite green body was post-cured in an air-circulated oven at 120° C. for 8 hours. The post-cured graphite foil-C/C composite was carbonized (first carbonization) in a furnace in nitrogen atmosphere at 1100° C. for 1 hour at a heating rate of 1° C./min. The carbonized composite was graphitized at 1900° C. for 1 hour in a furnace with argon atmosphere.

After graphitization treatment, the PAN/resin-based and PAN/pitch-based composite were densified by vacuum impregnation of a resole-type phenolic resin (PF-650, Chang Chun Plastics Co. Ltd., Taiwan) at the temperature of 25-30° C., followed by curing at 180° C. for 2 hours and carbonization at 1100° C. for 1 hour with a heating rate of 3° C./min in a furnace with nitrogen atmosphere. Such impregnation/curing/carbonization cycle was repeated four times to obtain a desired density. After the densification procedure, final graphitization treatment at 1900° C. for 60 min in a furnace with argon atmosphere was applied to specimen.

The PAN/resin-based prepreg and PAN/pitch-based prepreg-derived graphite foil-C/C composite samples were designated “R/R-R3” and “P/R-R3”, respectively. The test methods for density, porosity and three-point bending properties are same as described in Example 2. Table 4 shows that PAN/resin-based prepreg-derived graphite foil-C/C composite has lower porosity, higher flexural strength and lower flexural toughness values than those of PAN/pitch-based prepreg derived graphite foil-C/C composite.

TABLE 4
Density, porosity and three-point bending properties
of inventive graphite foil-C/C composites

| Sample | Density | | Flexural | Flexural |
|---|---|---|---|---|
| code | (g/cm³) | Porosity (%) | strength (MPa) | toughness (MPa) |
| R/R-R3 | 1.36 ± 0.02 | 8.58 ± 0.72 | 77.2 ± 11.2 | 0.31 ± 0.026 |
| P/R-R3 | 1.35 ± 0.03 | 11.07 ± 2.14 | 58.8 ± 4.0 | 0.72 ± 0.166 |

### Example 4

### Manufacturing of Inventive Graphite Foil-C/C Composites with Different Graphite Foil Installation Timings

The present example shows the graphite foil installation timings of inventive graphite foil-C/C composites. A piece of graphite foils was installed at three different fabrication steps. One was at the hot-pressing, another was at the third impregnation/baking/carbonization cycle, and the other was at the final graphitization (2^{nd} graphitization) (Table 5).

G(O)PR and G(3D)PR graphite foil-C/C composites were manufactured as follows:

### G(O)PR

Five pieces of PAN-based 2D woven cloths (TR3523M, Mitsubishi Rayon Co., Japan) were laid-up and punch-needled. During the punch-needled, 171 needles punched on the woven cloths for 500 times. The area of punch-needled was a square of 5 cm in length. The needled felt was impregnated by the vacuum impregnation process with a petroleum pitch (A240, Ashland Oil Company, USA) at the temperature of 250-300° C. The pitch-impregnated woven was baked in an oven at 50° C. for 6 hours to remove solvent from the pitch and form a PAN/pitch-based prepreg. The PAN/pitch-based prepreg was cut to a square of 5 cm in length, followed by hot-pressing in a stainless steel mold at 120° C. for 30 min under a pressure of 5 MPa to form a graphite foil-C/C composite green body.

Prior to the hot-pressing, a piece of graphite foil was installed onto C/C prepreg. The piece of graphite foil (GRAFOIL® GTA flexible graphite foil, Graftech International Ltd., USA) was shaped to a square of 5 cm in length, roughened by sand blast with the pressure of 20 psi for 1 sec, and laid-up (stacked) on top of the prepreg.

The hot-pressed composite green body was post-cured in an air-circulated oven at 120° C. for 8 hours. The post-cured graphite foil-C/C composite was carbonized (first carbonization) in a furnace in nitrogen atmosphere at 1100° C. for 1 hour at a heating rate of 10° C./min. The carbonized composite was graphitized at 1900° C. for 1 hour in a furnace with argon atmosphere. After graphitization treatment, the PAN/pitch-based composite was densified by vacuum impregnation of a resole-type phenolic resin (PF-650, Chang Chun Plastics Co. Ltd., Taiwan) at the temperature of 25-30° C., followed by curing at 180° C. for 2 hours and carbonization at 1100° C. for 3 min with a heating rate of 1000° C./min in a furnace with nitrogen atmosphere. Such impregnation/curing/carbonization cycle was repeated four times to obtain a desired density.

### G(3D)PR

After the third impregnation/curing/carbonization cycle, a piece of graphite foil was installed onto the 3rd-cycle densified C/C composite. The resin-impregnated C/C was baked in an oven at 70° C. for 6 hours to remove solvent from the resin. The piece of graphite foil (GRAFOIL® GTA flexible graphite foil, Graftech International Ltd., USA) was shaped to a square of 5 cm in length, roughened by sand blast with the pressure of 20 psi for 1 sec, and laid-up (stacked) on top of the resin-impregnated C/C composite, followed by hot-pressing in a stainless steel mold at 160° C. for 30 min under a pressure of 5 MPa to form a graphite foil-C/C composite. The graphite foil-C/C composite was post-cured in an air-circulated oven at 230° C. for 8 hours. The post-cured graphite foil-C/C composite was carbonized in a furnace in nitrogen atmosphere at 1100° C. for 1 hour at a heating rate of 10° C./min. After graphite foil installation, the forth impregnation/curing/carbonization cycle was repeated. The product obtained is designated as G(3D)PR.

After the densification procedure, pre-graphitization treatment at 1100° C. for 60 min with a heating rate of 10° C./min in a furnace with nitrogen atmosphere and final graphitization treatment at 1900° C. for 60 min in a furnace with argon atmosphere was applied to specimen.

G(2G)PR-R3 graphite foil-C/C composites was manufactured as follows:

Five pieces of PAN-based 2D woven cloths (TR3523M, Mitsubishi Rayon Co., Japan) were laid-up and punch-needled. During the punch-needled, 171 needles punched on the woven cloths for 500 times. The area of punch-needled was a square of 5 cm in length. The needled felt was impregnated by the vacuum impregnation process with a petroleum pitch (A240, Ashland Oil Company, USA) at the temperature of 250-300° C. The pitch-impregnated woven was baked in an oven at 50° C. for 6 hours to remove solvent from the pitch and form a PAN/pitch-based prepreg. The PAN/pitch-based prepreg was cut to a square of 5 cm in length, followed by hot-pressing in a stainless steel mold at 120° C. for 30 min under a pressure of 5 MPa to form a graphite foil-C/C composite green body. The hot-pressed composite green body was post-cured in an air-circulated oven at 120° C. for 8 hours. The post-cured graphite foil-C/C composite was carbonized (first carbonization) in a furnace in nitrogen atmosphere at 1100° C. for 1 hour at a heating rate of 1° C./min. The carbonized composite was graphitized at 1900° C. for 1 hour in a furnace with argon atmosphere. After graphitization treatment, the PAN/pitch-based composite was densified by vacuum impregnation of a resole-type phenolic resin (PF-650, Chang Chun Plastics Co. Ltd., Taiwan) at the temperature of 25-30° C., followed by curing at 180° C. for 2 hours and carbonization at 1100° C. for 1 hour with a heating rate of 3° C./min in a furnace with nitrogen atmosphere. Such impregnation/curing/carbonization cycle was repeated four times to obtain a desired density. After the densification procedure, final graphitization treatment (2^{nd} graphitization) at 1900° C. for 60 min in a furnace with argon atmosphere was applied to specimen.

After the second graphitization treatment, a piece of graphite foil was installed onto second graphitized C/C composite. The second graphitized C/C composite was impregnated by the vacuum impregnation process with a resole-type phenolic resin (PF-650, Chang Chun Plastics Co. Ltd., Taiwan) at the temperature of 25-30° C. The resin-impregnated C/C was baked in an oven at 70° C. for 6 hours to remove solvent from the resin. The piece of graphite foil (GRAFOIL® GTA flexible graphite foil, Graftech International Ltd., USA) was shaped to a square of 5 cm in length, roughened by sand blast with the pressure of 20 psi for 1 sec, and laid-up (stacked) on top of the resin-impregnated C/C composite, followed by hot-pressing in a stainless steel mold at 160° C. for 30 min under a pressure of 5 MPa to form a graphite foil-C/C composite. The graphite foil-C/C composite was post-cured in an air-circulated oven at 230° C. for 8 hours. The post-cured graphite foil-C/C composite was carbonized in a furnace in nitrogen atmosphere at 1100° C. for 1 hour at a heating rate of 10° C./min.

For cross-sectional SEM examination, samples were cut and mounted in epoxy resin, followed by polishing using SiC sand paper.

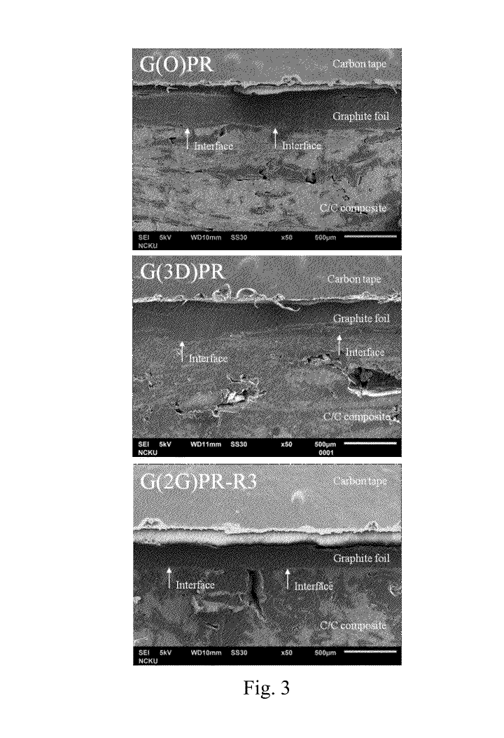

The cross-sectional scanning electron micrographs (FIG. 3) show that the graphite foil-C/C interface is tight and the graphite foil itself is dense in all samples.

TABLE 5
Materials and installation timing for preparing
the composite samples for the study

| Sample code | Graphite foil installation timing |
|---|---|
| G(O)PR | onto C/C prepreg |
| G(3D)PR | onto the3^{rd}-cycle densified C/C composite. |
| G(2G)PR-R3 | onto the 2^{nd} graphitized C/C composite |

### Example 5

### Water Contact Angle Measurement

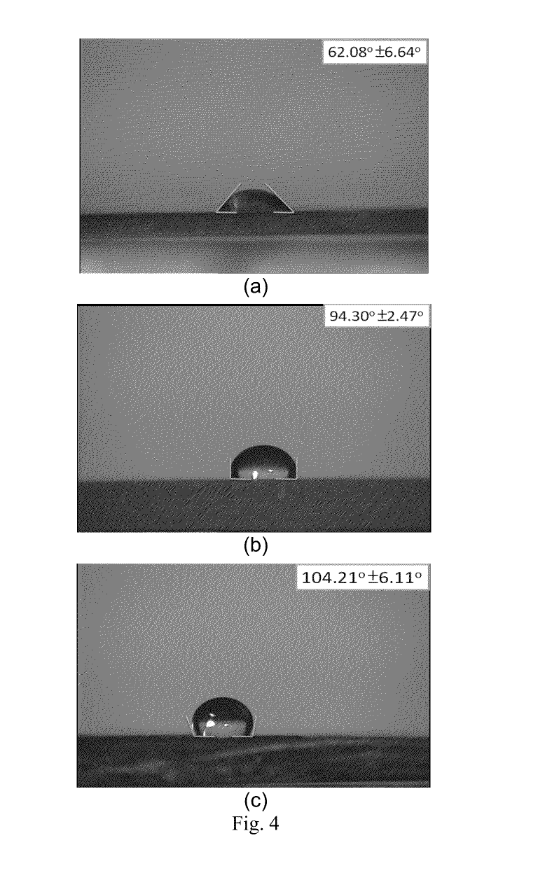

The water contact angles of three different carbonaceous materials, including a C/C composite in the absence of graphite foil, a commercial high density graphite (G348, Tokai Carbon Co. Ltd., Japan) (with a density of 1.78), and an inventive graphite foil-C/C composite prepared according to the method given in Example 1, were measured and compared. The results are shown in FIG. 4. The C/C composite sample was prepared by the same process as that for preparing the inventive graphite foil-C/C composite except being made without a graphite foil.

It is clearly seen that, among the three materials, the inventive graphite foil-C/C composite has the largest water contact angle, implying the lowest water permeability. This result can be explained by the dense structure and highly aligned basal planes (parallel to the composite surface) of the water-contacting graphite foil in the inventive graphite foil-C/C composite.

### Example 6

### Corrosion and Hermetic Behavior of an Inventive Graphite Foil-C/C Composite in Flinak

The corrosion and hermetic behavior of an inventive graphite foil-C/C composite in “Flinak” molten fluoride salts (a mixture of LiF, NaF and KF salts) was investigated. The inventive-graphite foil-C/C composite was manufactured following the same procedures given in Example 2 and designated R/R. The Flinak used in this example was prepared by dry-mixing appropriate amounts of LiF (Lithium fluoride 98.5%, Alfa Aesar, USA), NaF (Sodium fluoride 99%, Alfa Aesar, USA), and KF (Potassium fluoride 98.5%, Alfa Aesar, USA) salts in a weight ratio 29.3:11.7:59.0, followed by heating in a graphite crucible to 500° C. for 3 hours in argon atmosphere. For easier interpretation of the immersion test data, the graphite foil-C/C composite sample was covered by a graphite foil (SIGRAFLEX® C, SGL group, German), except one surface (a broad face) was exposed to the molten Flinak. As a comparison, from the surface of another graphite foil-C/C composite sample, a 0.5 mm dia. hole was drilled through the graphite foil zone so that the underneath C/C structure within this hole was exposed to the molten salt during immersion. These two samples (with and without hole) were then immersed in the Flinak molten salt heated to the temperature of 800° C. in argon atmosphere for 1 hour.

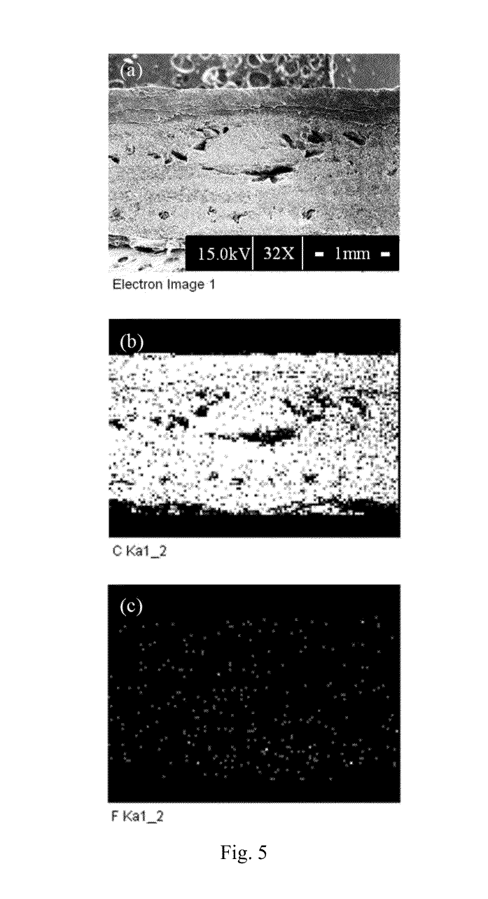

A cross-sectional scanning electron micrograph and EDS elemental mapping of C and F of the R/R type composite sample are shown in FIG. 5. It is worth noting, in FIG. 5(a), that both the graphite foil and the underneath C/C structure are substantially intact after exposure to the high temperature, highly corrosive environment. The graphite foil-C/C interface, again, remains very tight. FIG. 5(b) and FIG. 5(c) show respectively the EDS “dot maps” of C and F of the same area.

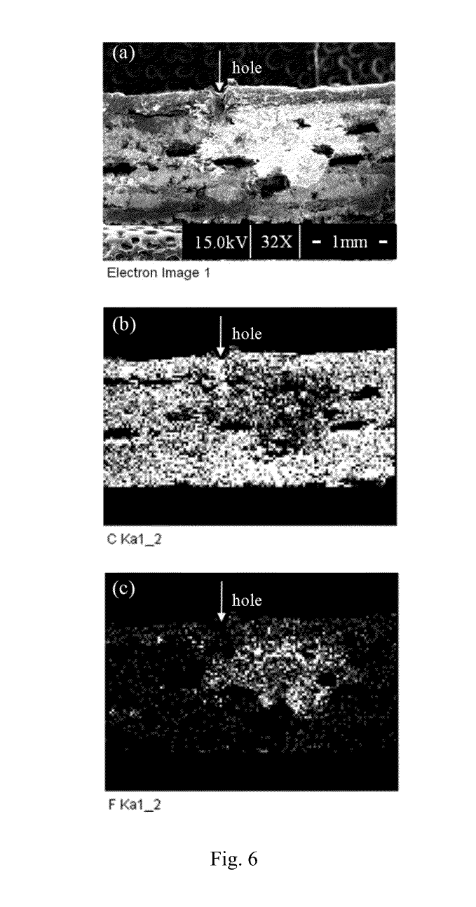

A cross-sectional scanning electron micrograph and EDS elemental mapping of C and F of the R/R type composite sample are shown in FIG. 6. It is clearly seen, in FIG. 6 (a), that the C/C structure was severely attacked by the fluoride salt penetrating through the hole, as indicated by the arrow. This result clearly indicates that the inherently porous C/C structure by itself is vulnerable to molten Flinak attack. With the protection of even one layer of graphite foil, however, its corrosion resistance and hermetic performance are dramatically improved.

### Example 7

### Flinak Immersion Test of an Inventive Composite and Nuclear Grade Graphite

The corrosion behavior of an inventive graphite foil-C/C composite and a nuclear grade graphite (NBG-18, SGL group, German) in Flinak molten fluoride salts (a mixture of LiF, NaF, and KF salts) was investigated. The inventive graphite foil-C/C composite was manufactured following the same procedures given in Example 3 and designated R/R-R3. The Flinak used is this example was prepared by dry-mixing appropriate amounts of LiF (Lithium fluoride 98.5%, Alfa Aesar, USA), NaF (Sodium fluoride 99%, Alfa Aesar, USA), and KF (Potassium fluoride 98.5%, Alfa Aesar, USA) salts in a weight ratio of 29.3:11.7:59.0, followed by heating in a graphite crucible to 500° C. for 3 hours in argon atmosphere. All samples were immersed for 90 hours in the Flinak molten salt heated to 800° C. in argon atmosphere. After immersed test, the sample was cleaned by immersing in the 1M aqueous solution of Al(NO₃)₃ (Aluminum nitride 98+%, Alfa Aesar, USA) at 300° C. to remove Flinak in the sample.

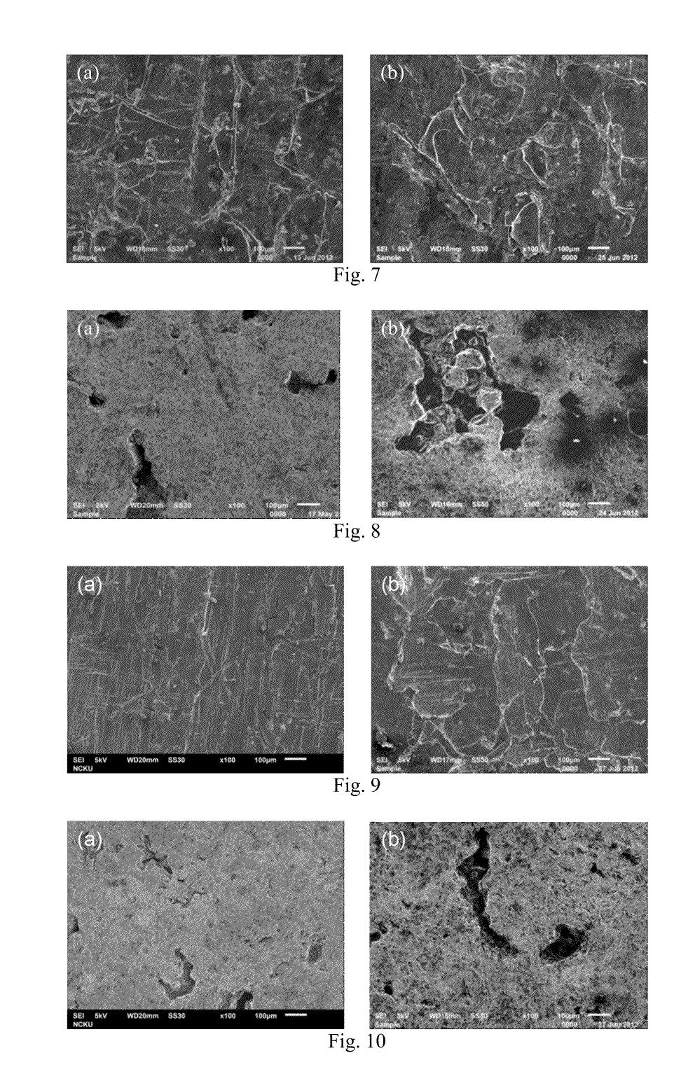

FIG. 7 clearly demonstrates the excellent corrosion resistance of the inventive graphite foil-C/C composite in Flinak at 800° C. On the other hand, the unprotected NBG-18 nuclear grade graphite appears vulnerable to the attack of the highly corrosive molten salt, as shown in FIG. 8.

### Example 8

### Flinak Erosion-Corrosion Test of an Inventive Composite and Nuclear Grade Graphite

An erosion-corrosion test was conducted on the same kinds of samples in the same Flinak molten salt as described in Example 7. The erosion-corrosion behavior of an inventive graphite foil-C/C composite (designated R/R-R3 in Example 3) and a nuclear grade graphite (NBG-18, SGL group, German) in the Flinak molten fluoride salt was investigated. The erosion-corrosion test was conducted using a homemade erosion testing system, wherein the sample surface to be eroded was designed to have a 45-degree angle with the axle that holds the sample. After the molten salt was heated to 750° C. in argon atmosphere for 1 h, samples were sunk into the molten salt. The erosion test was conducted with a rotation speed of 150 rpm at 750° C. for 24 h. After erosion-corrosion test, the sample was cleaned by immersing in the 1 M aqueous solution of Al(NO₃)₃ (Aluminum nitride 98+%, Alfa Aesar, USA) at 300° C. to remove Flinak in the sample.

FIG. 9 clearly demonstrates the excellent corrosion resistance of the inventive graphite foil-C/C composite in Flinak at 800° C. On the other hand, the unprotected NBG-18 nuclear grade graphite appears vulnerable to the attack of the highly corrosive molten salt, as shown in FIG. 10.

### Example 9

### Manufacturing of an Inventive Graphite Foil-Graphite Composite

A piece of high density graphite plate (G348, Tokai Carbon Co. Ltd., Japan) was vacuum-impregnated and coated with a layer of resole-type phenolic resin (PF-650, Chang Chun Plastics Co. Ltd., Taiwan), that was subsequently baked in an oven at 80° C. for 6 h to remove solvent from the resin. The baked resin-coated graphite plate was sandwiched between two pieces of sandblasted (surface-roughened) graphite foils (GRAFOIL® GTA, Graftech International Ltd., USA), followed by hot-pressing in a stainless steel mold at 160° C. for 30 min under a pressure of 5 MPa to form a graphite foil-graphite composite. The hot-pressed composite was post-cured in an air-circulated oven at 230° C. for 8 h, followed by a carbonization treatment in a furnace in nitrogen atmosphere at 1100° C. for 1 h at a heating rate of 10° C./min and a graphitization treatment at 1900° C. for 1 h with argon atmosphere.

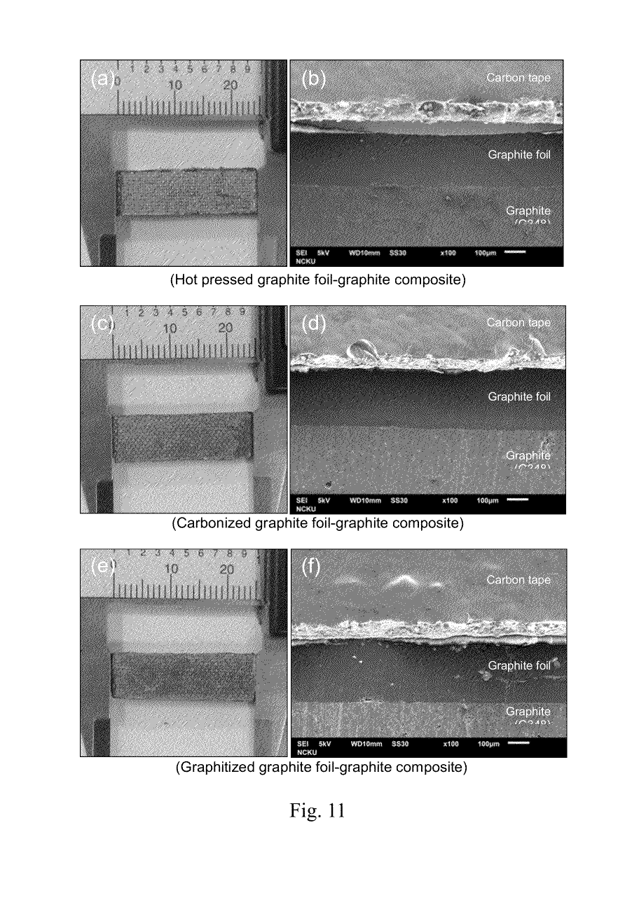

FIG. 11 clearly shows that, even after the high temperature graphitization treatment, the graphite foil was tightly adhered to the graphite substrate.

### Example 10

### Manufacturing of Inventive Graphite Foil-Metal Composites by Diffusion Bonding

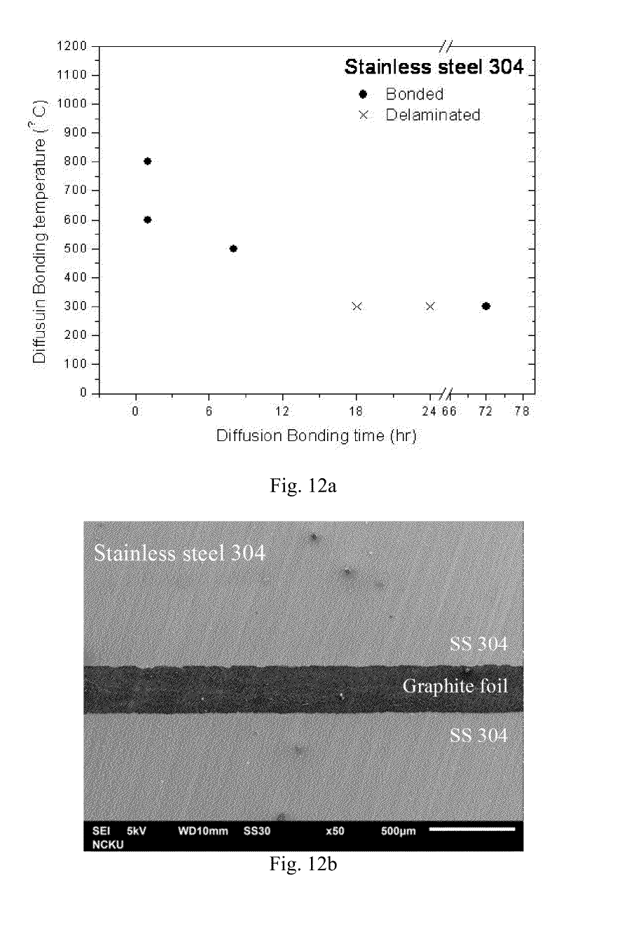

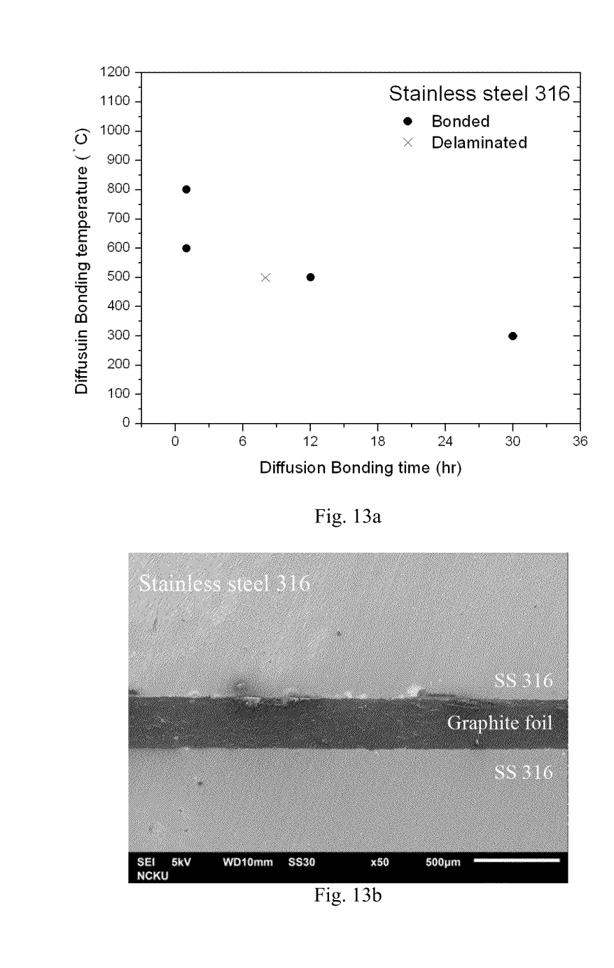

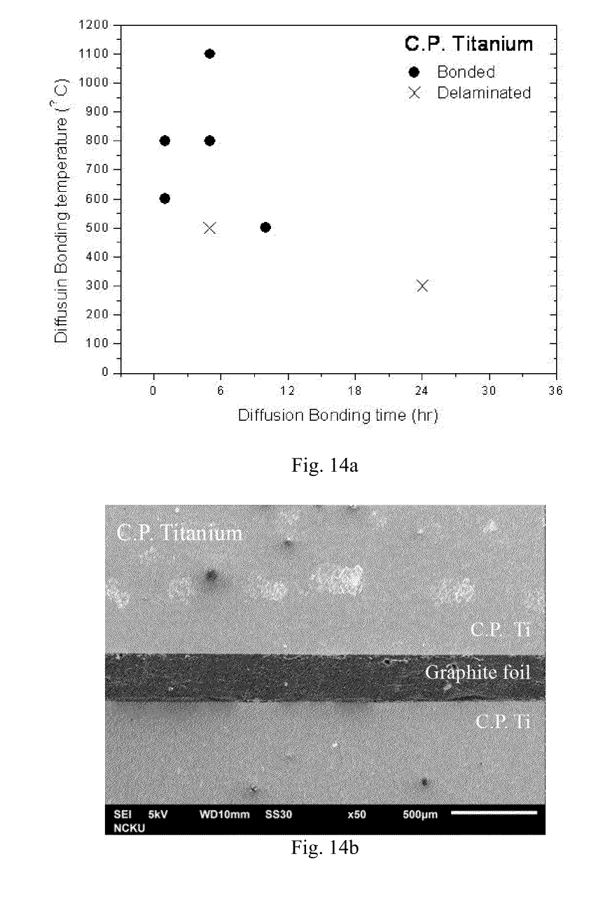

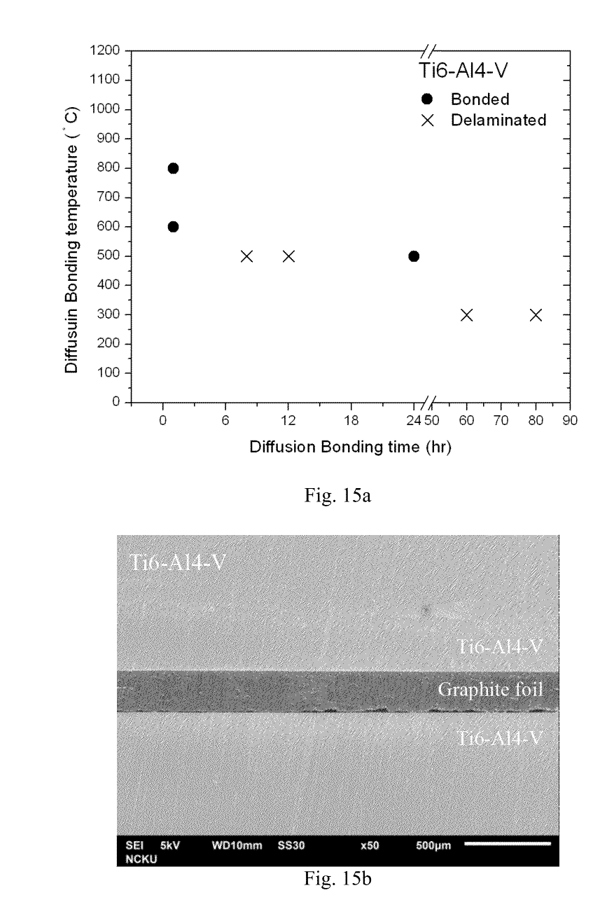

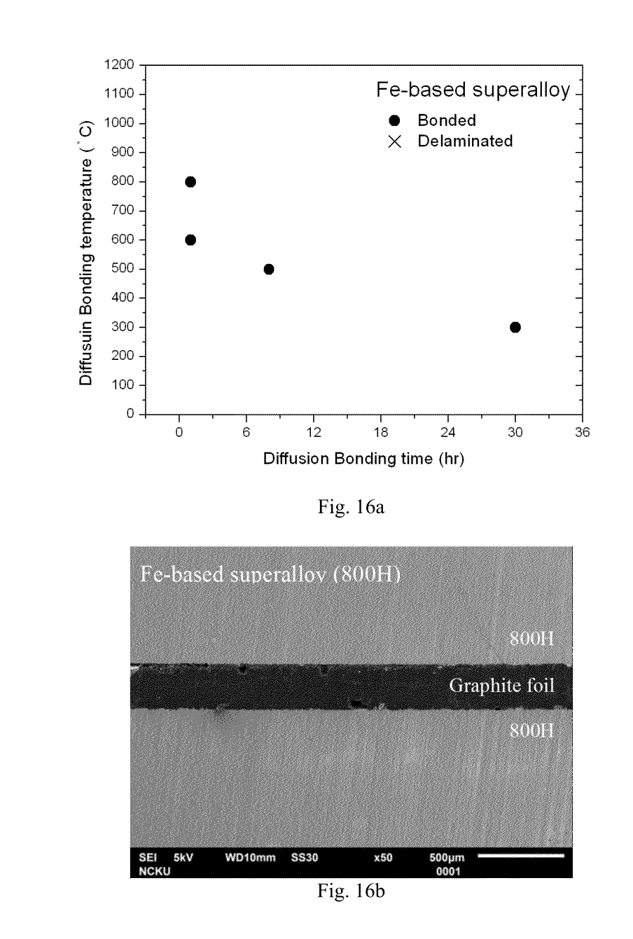

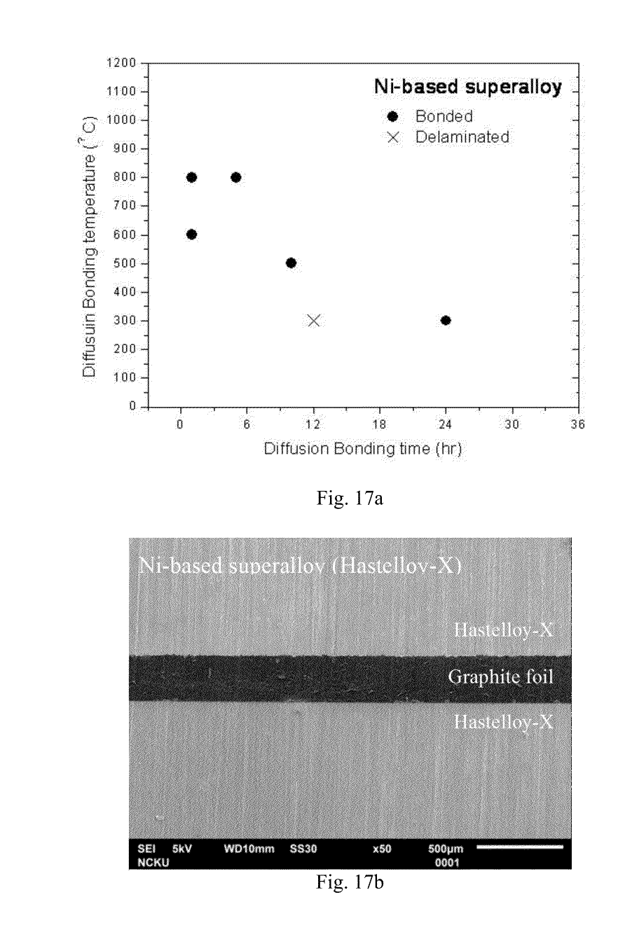

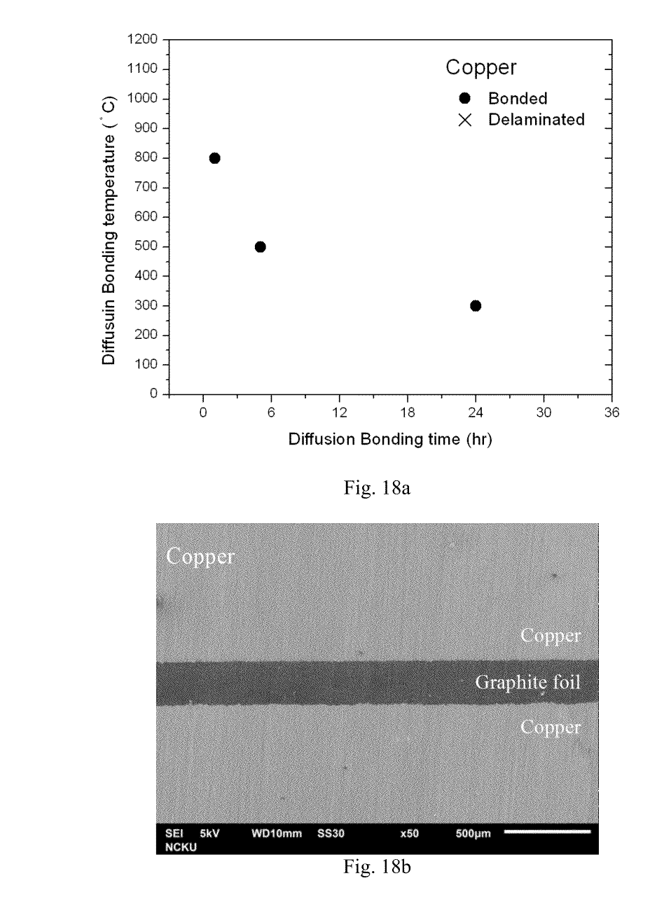

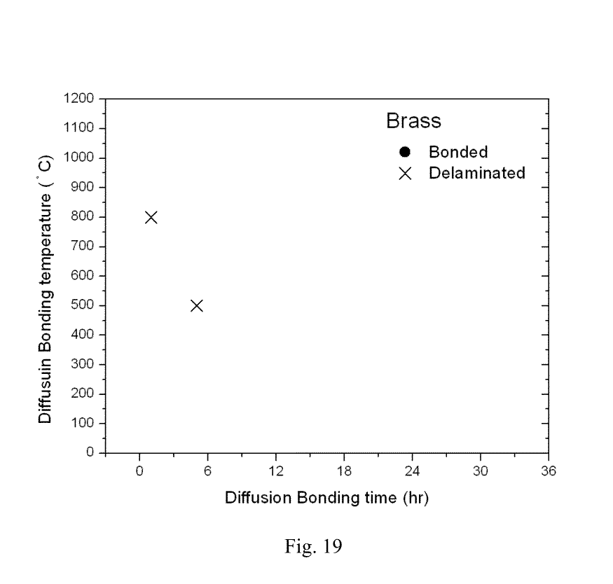

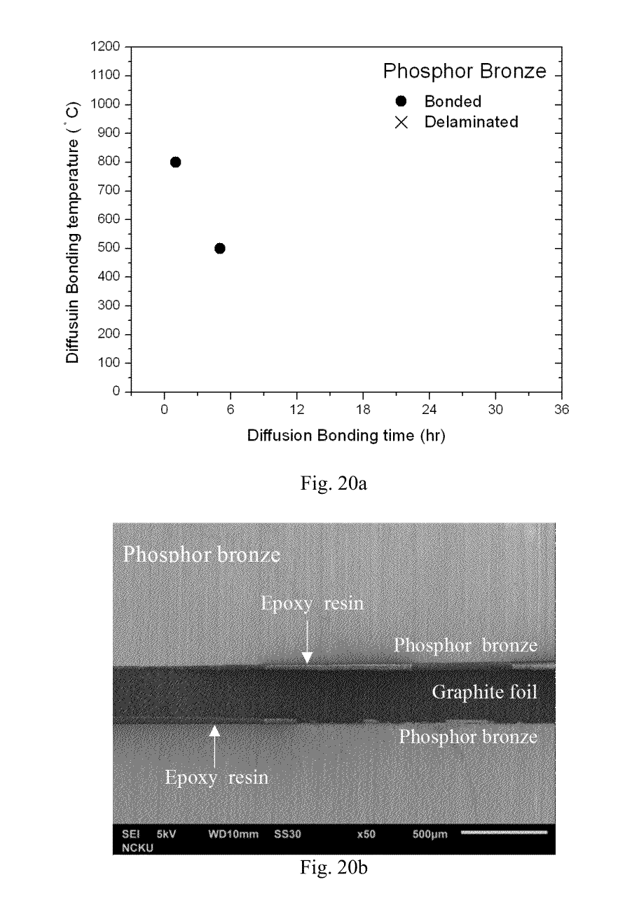

Graphite foils were diffusion-bonded onto a series of popularly used commercial metals, including stainless steel (SS304, Yieh United Steel Corp., Taiwan and SS316, Yieh United Steel Corp., Taiwan), commercially pure titanium (c.p. Ti, Grade2, China), titanium alloy (Ti-6Al-4V, China), superalloy (Alloy 800(H), China Steel Corp., Taiwan and Hastelloy® X, Haynes International Inc., USA), copper (C1100, First Copper Technology Co., Ltd, Taiwan), and copper alloy (brass C2680, First Copper Technology Co., Ltd, Taiwan and bronze C5191, Minchali Metal Industry Co., Ltd, Taiwan). A piece of graphite foil (GRAFOIL® GTA, Graftech International Ltd., USA) was sandwiched between two pieces of metal. To enhance bonding, the surface of the metal was roughened by SiC sand paper. The stacked sandwich was mechanically fastened by two screws, each near a corner of the sandwich. Diffusion bonding treatment was conducted in an argon-filled furnace heated to a temperature from 300 to 1100° C. The diffusion-bonded graphite foil-metal composite samples were cut by an abrasive cutting wheel. The cross-sections of the composite samples were examined to evaluate the graphite foil-metal substrate bonding behavior. The results in FIGS. 12-20 indicate that, under certain heat treatment (diffusion bonding) conditions, all the investigated substrate metals can be adherently bonded to the graphite foil to successfully form the inventive graphite foil-metal composites.

### Example 11

### Manufacturing of Inventive Graphite Foil-Metal Composites by Hot Pressing

A metal plate was sandblasted, cleaned, and dipped in a resole-type phenolic resin (PF-650, Chang Chun Plastics Co. Ltd., Taiwan) for 10 min. The resin-coated metal was baked in an oven at 80° C. for 6 h to remove solvent from the resin. A piece of graphite foil was laid up onto the resin-coated metal, followed by hot-pressing in a stainless steel mold at 160° C. for 30 min under a pressure of 5 MPa to form a graphite foil-metal composite. The hot-pressed composite was post-cured in an air-circulated oven at 230° C. for 8 h. The hot pressing-bonded graphite foil-metal composite samples were cut by an abrasive cutting wheel. The cross-sections of the composite samples were examined to evaluate the graphite foil-metal substrate bonding behavior. The results indicate that all the investigated substrate metals can be adherently hot pressing-bonded to the graphite foil to successfully form the inventive graphite foil-metal composites. Optionally the post-cured graphite foil-metal composite samples may be further carbonized for high temperature applications.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

1. A composite comprising a layered structure comprising a graphite foil bonded to a surface of a substrate, wherein the graphite foil comprises a laminate of a plurality of natural graphite flakes parallel to the surface of the substrate, wherein the graphite foil and the surface of the substrate are bonded through diffusion bonding directly, or bonded with a cured resin, a cured pitch, a carbonized resin, a carbonized pitch, a graphitized resin or a graphitized pitch in between, wherein the graphite foil contains not less than 95%, preferably 99%, of carbon.

2. The composite of claim 1, wherein the substrate is a metallic or ceramic substrate, preferably a metallic substrate, and the graphite foil and the surface of the substrate are bonded through diffusion bonding directly.

3. The composite of claim 2, wherein the metallic substrate is stainless steel, titanium, a titanium alloy, a superalloy, copper, a copper alloy or an aluminum alloy.

4. The composite of claim 1, wherein the substrate is a metallic, ceramic, carbonaceous or polymeric substrate, and the graphite foil and the surface of the substrate are bonded with a cured resin, a cured pitch, a carbonized resin, a carbonized pitch, a graphitized resin or a graphitized pitch, in between.

5. The composite of claim 4, wherein the resin is a thermosetting resin.

6. The composite of claim 5, wherein the substrate is a carbonaceous substrate, and preferably, the carbonaceous substrate is a carbon fiber-reinforced carbon matrix composite substrate or a graphite block substrate, and preferably a carbon fiber-reinforced carbon matrix composite substrate.

7. The composite of claim 5, wherein the metallic substrate is a stainless steel, a titanium, titanium alloy, a superalloy, copper, a copper alloy or an aluminum alloy.

8. The composite of claim 1, wherein the substrate is in the form of a pipe or tank and the surface is an inner wall of the pipe or tank.

9. A process of making a composite comprising placing a flexible graphite foil onto a surface of a metallic or ceramic substrate, preferably a metallic substrate, to form a layered structure; and diffusion bonding the flexible graphite foil and the surface of the substrate by compressing the layered structure in an inert atmosphere or under vacuum at a temperature of 200-1200° C., preferably 300-1100° C., wherein the flexible graphite foil comprises a laminate of a plurality of natural graphite flakes parallel to the surface of the substrate, wherein the flexible graphite foil contains not less than 90%, preferably 95%, of carbon.

10. The process of claim 9, wherein the metallic substrate is stainless steel, titanium, a titanium alloy, a superalloy, copper, a copper alloy or an aluminum alloy.

11. A process of making a composite comprising providing a substrate and a flexible graphite foil, wherein the substrate, the flexible graphite or both comprise resin or pitch deposited on a surface thereof; placing a flexible graphite foil onto the surface of the substrate to form a layered structure, wherein the flexible graphite foil comprises a laminate of a plurality of natural graphite flakes parallel to the surface of the substrate, and the flexible graphite foil contains not less than 90%, preferably 95%, of carbon; and compressing the layered structure at an elevated temperature, so that at least a portion of resin or pitch is softened and flows between the graphite foil and the substrate.

12. The process of claim 11, wherein the substrate is provided with resin or pitch deposited on a surface thereof, and the flexible graphite foil does not comprise resin or pitch.

13. The process of claim 11, wherein the compressing is carried out at a temperature of 50-300° C., preferably 100-200° C., and a pressure of 1-100 MPa, preferably 1-50 MPa, for a period of 1-1000 minutes, preferably 1-100 minutes.

14. The process of claim 11, wherein the resin is a thermosetting resin, and the substrate is a metallic, ceramic, carbonaceous, or a polymeric substrate.

15. The process of claim 12, wherein the substrate is a carbonaceous substrate, and preferably, the carbonaceous substrate is a carbon fiber-reinforced resin matrix composite substrate, a carbon fiber-reinforced pitch matrix composite substrate, a resin or pitch impregnated carbon fiber-reinforced carbon matrix composite substrate or a resin or pitch impregnated graphite block substrate.

16. The process of claim 12, wherein the substrate is a resin-coated metallic substrate, preferably the metallic substrate is a stainless steel, a titanium, titanium alloy, a superalloy, copper, a copper alloy or an aluminum alloy.

17. The process of claim 11 further comprising post-curing at least partially cured resin or pitch in the compressed layer structure.

18. The process of claim 16 further comprising carbonizing, and optionally graphitizing the post-cured resin or post-cured pitch.

19. The process of claim 9, wherein the surface of the flexible graphite foil or the substrate is roughened prior to the flexible graphite foil being placed onto the surface of the substrate.

20. The process of claim 11, wherein the surface of the flexible graphite foil or the substrate is roughened prior to the flexible graphite foil being placed onto the surface of the substrate.

21. The process of claim 9, wherein the substrate is in the form of a pipe or tank and the surface is an inner wall of the pipe or tank.

22. The process of claim 11, wherein the substrate is in the form of a pipe or tank and the surface is an inner wall of the pipe or tank.
